(19) United States
(12) Patent Application Publication
(10) Pub. No.: US 2007/0295119 A1
(43) Pub. Date: Dec. 27, 2007

(54) STARTING DEVICE FOR A THERMAL ENGINE

(76) Inventor: Jean-Sebastien METRAL, La Verpilliere (FR)

Correspondence Address: BERENATO, WHITE & STAVISH, LLC, 6550 ROCK SPRING DRIVE, SUITE 240, BETHESDA, MD, 20817, US

(21) Appl. No.: 11/762,363

(22) Filed: Jun. 13, 2007

(30) Foreign Application Priority Data
Jun. 27, 2006 (FR) 0652677

(51) Int. Cl. F02N 15/06; F02N 15/02; F02N 15/04

(52) U.S. Cl. 74/7 E

(57) ABSTRACT

The invention proposes a starting device for a thermal engine able to equip a transport vehicle. This starting device comprises an electric motor equipped with a field winding with permanent magnets, a speed reducer 4 coupled to the electric motor and to the thermal engine and a mounting support 2 in which the electric motor and the speed reducer 4 are mounted. This speed reducer 4 comprises a ring 46, at least one damping element intended to limit an angular movement due to a torsion movement between the speed reducer 4 and the housing support 2 and at least one centring element intended to facilitate the assembly of the speed reducer 4 and mounting support 2. At least one damping element and at least one centring element are formed in a single elastic metal piece 7′ and the elastic metal piece 7′ comprises an extension 72′ for holding the permanent magnets 31′.

### FIELD OF THE INVENTION

The present invention concerns in general terms starters for transport vehicles and in particular cars.

### BACKGROUND OF THE INVENTION

More particularly, the invention concerns a starter comprising an electric motor, a speed reducer coupled to the electric motor and to a thermal engine, a mounting support forming a housing in which the electric motor and the speed reducer are mounted, the speed reducer comprising a ring, at least one damping element intended to limit an angular movement due to a torsion movement between the speed reducer and the mounting support and at least one centring element intended to facilitate the assembly of the speed reducer and mounting support.

In this type of starter problems are usually posed relating to the limitation of the maximum torque transmitted between the output shaft of the electric motor and the output shaft of the starter. This is because, during the driving phase, the thermal engine compression times cause variations in load and the taking up of angular clearances in the various gears. This results in vibrations and impacts detrimental to the service life of the starter. A damping means intended to absorb these impacts is therefore necessary.

Moreover, there exists a problem with positioning during the operation of assembling the speed reducer and the mounting support. Which generally makes it necessary to provide means providing a centring function between these elements.

The patent FR2787833 of the applicant describes a motor vehicle starter comprising an electric motor and a speed reducer arranged in a housing. The electric motor drives a starter head in rotation. The speed reducer is interposed between the electric motor and the starter head and comprises a ring. The ring comprises studs made from elastomer material that are interposed by an insert moulding method between the toothed ring and complementary portions situated in a cavity of the housing. A torsion damping function is thus provided by these studs made from elastomer material so as to absorb the undesirable mechanical impacts. In addition, the centring function mentioned above, between the speed reducer and the housing, is provided by dedicated positioning means.

The technical solutions adopted in this starter according to the patent FR2787833 are overall satisfactory. However, in certain applications, because of their reduced resistance to wear, the elastomer materials may not be suitable in terms of increase in the service life of the starter. In addition, the increasing cost and quality constraints to which automotive equipment manufacturers are subject are not very compatible with the insert moulding of elastomer materials, which remains a relatively expensive method.

### SUMMARY OF THE INVENTION

An object of the invention is to provide a starting device offering an increased service life and reduced cost compared with the solutions of the prior art.

A starting device for a thermal engine, according to the invention, able to equip a transport vehicle, in particular a car, comprises an electric motor equipped with a field wiring with permanent magnets, a speed reducer coupled to the electric motor and to the thermal engine and, a mounting support forming a housing, in which the electric motor and speed reducer are mounted, and the speed reducer comprises a ring, at least one damping element intended to limit an angular movement due to a torsion movement between the speed reducer and the mounting support and at least one centring element intended to facilitate the assembly of the speed reducer and mounting support. In accordance with the invention, at least one damping element and at least one centring element for the device are formed in a single elastic metal piece, and the elastic metal piece comprises an extension for holding the permanent magnets.

The invention takes advantage of this structure in a single elastic metal piece in order to fulfil at the same time the damping function, the centring function and the function of holding the permanent magnets.

Concerning the damping function, the use of a metal material in replacement for an elastomer material improves the service life of the starter by allowing an increased angular movement between the speed reducer and the mounting support. This advantage stems from a better shear strength of the metal material compared with elastomer materials and contributes to an improvement in the general robustness of the starter. Moreover, it should be noted that the authorised fatigue strength of the metal material is in general superior to that of elastomer material.

In addition, the cost of the starter is reduced by the use of a single piece for fulfilling two functions and through the use of a metal material less expensive than an elastomer material. In addition, the elastic metal piece guarantees a precise centring function of the speed reducer and mounting support during the assembly operation.

The characteristic according to which the elastic metal piece comprises an extension makes it possible to reduce the number of parts by giving the elastic metal piece an additional function of holding the permanent magnets.

According to other characteristics of the invention:
the elastic metal piece is interposed between the ring of the speed reducer and the mounting support.
the elastic metal piece is fixed to the mounting support.
the elastic metal piece has an anchoring portion able to be fixed to the mounting support.
the elastic metal piece is circumferentially acting.
the ring comprises a recess receiving the elastic metal piece.
the elastic metal piece has a substantially longitudinal shape and a substantially symmetrical transverse section comprising a planar central portion and two U-shaped or V-shaped parts on each side of the central portion. This form of the elastic metal piece affords better damping by virtue of greater angular movement and in addition helps to reduce wear. However, other shapes could be adopted by a person skilled in the art according to the applications of the invention. It should be noted that the choice of the shape is a parameter on which it is possible to act in order to minimise the shearing force on the elastic metal piece and improve the robustness of the starter.
The starting device for a thermal engine comprises a plurality of elastic metal pieces disposed between the ring and the mounting support, and the elastic metal pieces are distributed substantially at a circumference of the ring.
The elastic metal piece is produced by folding. It should be noted that a method of producing by folding offers the advantage of being relatively inexpensive and well controlled.

### BRIEF DESCRIPTION OF THE DRAWINGS

Other characteristics and advantages of the invention will emerge from a reading of the detailed description of several embodiments of the invention, with reference to the figures attached below, in which:

FIG. 1 is a view in axial section of a particular embodiment of a starting device according to the invention;

FIG. 2 is a view in three dimensions showing details of a speed reducer and a mounting support included in the device of FIG. 1;

FIG. 3 is a view in three dimensions showing the speed reducer and the mounting support of FIG. 2 in a non-assembled state;

FIG. 4 is a view in partial section along an axis A shown in FIG. 1 of the speed reducer and mounting support;

FIG. 5 is a view in three dimensions of the speed reducer and mounting support not assembled according to another particular embodiment of the invention.

### DESCRIPTION OF THE PREFERRED EMBODIMENTS

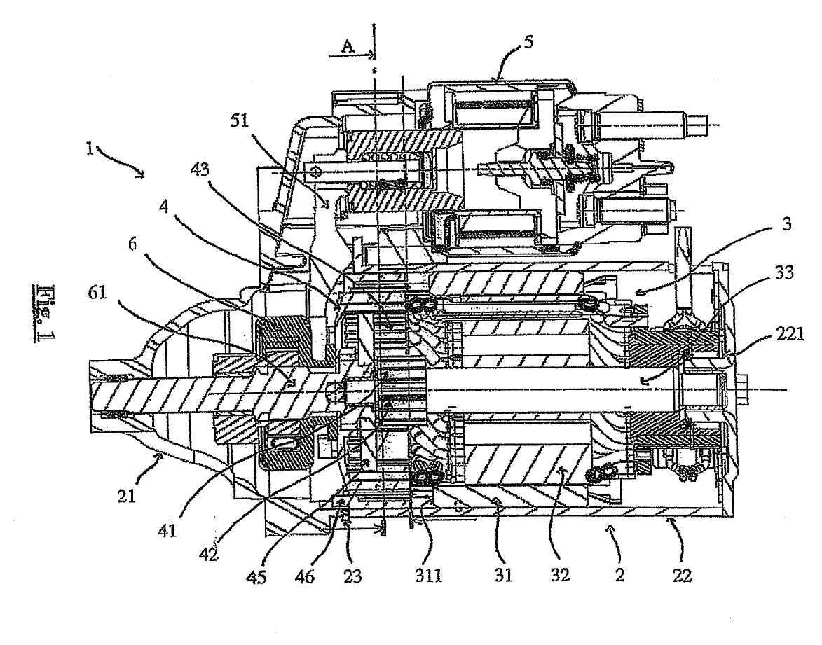

With reference to FIGS. 1 to 4, a first particular embodiment of the invention of a starter according to the invention, particularly adapted to a motor vehicle, is now described.

As shown in FIG. 1, the starter 1 comprises in a known manner a mounting support 2 that will be called a housing, composed of a front part 21 and a rear part 22. An electric motor 3 and a speed reducer 4 are mounted in the housing 2.

The starter 1 also comprises, in the rear part of the housing 22, a field winding 31 and an armature 32 that drives an armature shaft 33, or output shaft of the electric motor.

An electromagnetic contactor 5 acts in a known manner on a starter head 6, by means of a lever 51, for example, in the shape of a fork. The starter head 6 is housed in the front part of the housing 21. The starter head 6 is mounted so as to slide on a starter-head shaft 61. The starter-head shaft 61 is coaxial with the armature shaft 33 of the electric motor 3. The starter head 6 drives in rotation an output pinion (not shown) coupled to the thermal engine (not shown) during an operation of starting the latter. The coupling of the output pinion (not shown) and thermal engine (not shown) is normally made by gears. Naturally a person skilled in the art will find applications of the invention in a starter where the starter head 6 drives in rotation a pulley generally coupled by a belt to the thermal engine.

The purpose of the speed reducer 4 is to adapt the torque and speed characteristics of the electric motor 3 to the performance requirements on the output pinion (not shown), with a view to starting the thermal engine (not shown). This speed reducer 4 is interposed between a pinion 41 and the starter-head shaft 61. The pinion 41 is mounted at one end of the armature shaft 33. The pinion 41 is in engagement with the starter-head shaft 61 so that these components are driven in rotation by the armature shaft 33 when the electric motor 3 is supplied. The pinion 41 projects axially towards the front part of the housing 21, beyond a front face 311 of the field winding 31.

The speed reducer 4 can comprise an epicyclic train 42 as shown in FIG. 1. In a speed reducer of this type, the pinion 41 is called a sun pinion.

The sun pinion 41 cooperates with planet pinions 43 of the epicyclic train 42. The planet pinions 43 are mounted on shafts 44 carried on a planet-carrier plate 45 rotationally fixed to the starter-head shaft 61.

The epicyclic train 42 also comprises an internally toothed ring 46 in which the planet pinions 43 mesh. This ring 46 is free to rotate.

Fixing elements 23 make it possible to assemble the front housing parts 21 and rear housing parts 22. These fixing elements 23 are for example mounting screws.

In accordance with the invention, the starter 1 comprises at least one elastic metal piece that satisfies both the function of damping and the function of centring the speed reducer 4 and housing 2.

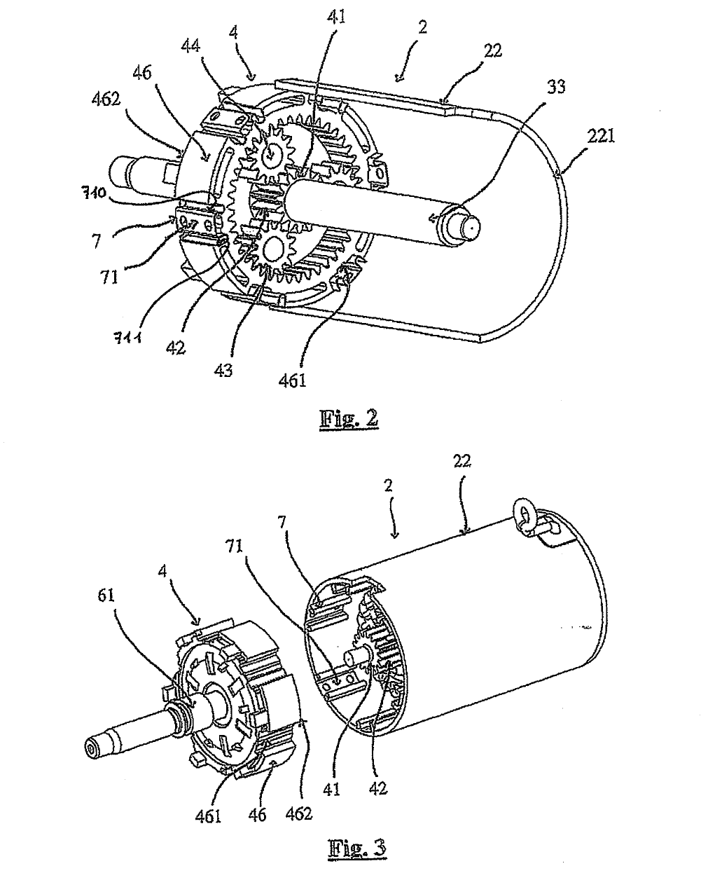

In the remainder of the description, this elastic metal piece is allocated the reference 7 and shown in FIGS. 2, 3 and 4 for this first particular embodiment of the invention.

The fulfillment of two functions in a single elastic metal piece 7 in particular reduces the cost of the starter 1 through the use of a metal material available at a reasonable cost compared with an elastomer material.

As appears clearly in FIGS. 2 to 4, this particular embodiment comprises six elastic metal pieces 7 interposed between the ring 46 of the speed reducer 4 and the housing 2, and more precisely between the speed reducer 4 and the rear housing part 22.

As shown in FIGS. 2 to 4, the elastic metal pieces 7 are fixed to the rear part of the housing 22, for example by means of rivets. Naturally other fixing means are possible such as screws or other methods known to persons skilled in the art.

The means (not shown) of fixing the elastic metal pieces 7 are mounted on one anchoring portion (71) disposed coaxially with the speed reducer 4 on the rear housing part 22.

The elastic metal pieces 7 have the characteristic of being circumferentially acting and therefore affording better damping through their location at the circumference 462 of the ring 46 of the speed reducer 4. The impact of the vibrations and shocks applied in the form of torque by the thermal engine to the ring 46 is thus limited effectively. The energy of the vibrations and shocks is dissipated by the elastic metal pieces 7 acted on by action forces exerted by the ring 46 and reaction forces due to the elasticity of these same elastic metal pieces 7 fixed to the housing 2. By arranging the elastic metal pieces 7 at the circumference 462, the amplitudes of the action and reaction forces and the oscillatory angular movements of the ring 46 are limited optimally. The risk of damaging the ring 46 is thus minimised and the service life of the starter 1 is increased.

As appears more particularly in FIG. 2, in this particular embodiment, the elastic metal pieces 7 have a longitudinal shape and a symmetrical transverse section comprising a substantially planar central portion corresponding to the anchoring portion 71 indicated previously, and two U-shaped parts 710 and 711 on each side of the portion 71. In a variant, the U-shaped parts are replaced by V-shaped parts that can be easily produced by a folding method. This shape allows better damping by virtue of greater angular movement between the speed reducer 4 and the housing 2. In addition, this shape helps to reduce the wear on the pieces and therefore to improve the service life of the starter 1. This is because an adopted shape of the elastic metal pieces 7 makes it possible to limit to a minimum the shearing force exerted on these and helps to prolong their service life. Naturally, the shape of the elastic metal pieces 7 is not limited to the longitudinal shape with a symmetrical transverse section more particularly described here, other symmetrical or non-symmetrical shapes are possible according to the applications of the invention. Advantageously, a metal sheet having great resistance to shearing can be used for producing the elastic metal pieces 7. According also to the application of the invention, the elastic metal pieces 7 can be metal profiled sections or others.

In the case of the production of elastic metal pieces from a metal sheet, a method of manufacture by folding can advantageously be used.

As shown in FIGS. 2, 3 and 4, in this particular embodiment of the invention, the elastic metal pieces 7 interposed between the ring 46 of the speed reducer 4 and the rear part of the housing 22 are received in recesses 461 in the ring 46. These recesses 461 provide better guidance during the operation of assembling the speed reducer 4 and the housing 2 and contribute to a simplification of the centring along a longitudinal axis of the starter corresponding to the axis of the ring 46.

As shown in FIG. 4 in this particular embodiment of the invention, the elastic metal pieces are distributed in a regular manner at a circumference 462 of the ring 46. In other embodiments, the elastic metal pieces 7 may not be disposed at a circumference of the ring 46 and may be distributed in an irregular manner.

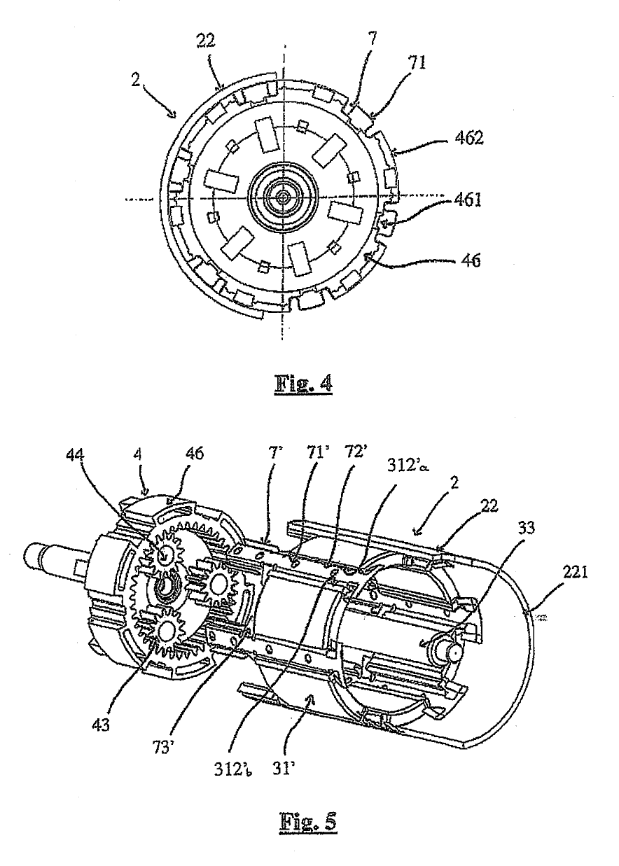

FIG. 5 shows another particular embodiment of the invention.

As will appear clearly hereinafter, this particular embodiment of the invention finds advantageous applications in the starters comprising an electric motor equipped with a field winding with permanent magnets.

It should be noted that, in the particular embodiment shown in FIG. 5, the elements having the same references are similar to those described above with reference to FIGS. 1 to 4 relating to the first particular embodiment of the invention.

As shown in FIG. 5, in this embodiment, the elastic metal pieces 7 described previously are replaced by elastic metal pieces 7′ that also fulfil a function of holding the permanent magnets 31′ when these permanent magnets 31′ are fitted in the housing 2 and during the functioning of the starter. For this purpose, the elastic metal pieces 7′ comprise an extension 72′. The extension 72′ extends axially towards a bottom 221 of the rear part of the housing 22.

The holding of the permanent magnets 31′ by the elastic metal pieces 7′ makes it possible to reduce the number of parts in the starter.

When the permanent magnets 31′ are fitted in the housing 2, the permanent magnets 31′ are not yet magnetised and holding elements are therefore necessary. In this particular embodiment of the invention, the holding elements consist of extensions 72′ of the elastic metal pieces 7′. A non-magnetised state of the permanent magnets 31′ facilitates the fitting of these in the rear part of the housing 22 by avoiding the presence of a magnetic attraction force between these permanent magnets 31′ and the housing 2.

The elastic metal pieces 7′ have, in this particular embodiment, a shape similar to that of the elastic metal pieces 7 described previously although having a greater length, which presents an advantage in terms of standardisation and reduction of costs. This is because the cross-sectional profile of the elastic metal pieces 7 and 7′ as shown in FIGS. 4 and 5 allows a lateral elasticity permitting forced insertion of the extensions 72′ between two opposite longitudinal faces 312′a and 312′b of the permanent magnets 31′. After insertion of all the extensions 72′ between the permanent magnets 31′, the elastic forces supplied by these ensure the holding of the permanent magnets 31′ on the housing 2. Naturally the elastic metal pieces 7′ can take various forms according to the permanent magnets used.

The extensions 72′ are fixed to the housing 2 by means known to persons skilled in the art, such as rivets or screws, as are the elastic metal pieces 7 described in the first particular embodiment of the invention. To this end, the elastic metal pieces 7′ comprise anchoring portions 72′ able to be fixed coaxially to the rear part of the housing 22.

As shown also in FIG. 5, in this particular embodiment of the invention, the elastic metal pieces 7′ also comprise tongues 73′ interposed between the ring 46 of the speed reducer 4 and the permanent magnets 31′. Each tongue 73′ is inclined radially with respect to the elastic metal piece 7′ and in particular its extension 72′. In addition, the direction of inclination of the tongue 73′ is situated towards the inside of the housing 2.

These tongues 73′ allow axial holding of the permanent magnets 31′ and ring 46, forming a stop for these components.

Naturally the invention is not limited to the particular embodiments described in the present application. It is clear that various modifications can be made by a person skilled in the art according to the applications envisaged, without for all that departing from the scope of the accompanying claims.

What is claimed is:

1. Starting device for a thermal engine able to equip a transport vehicle, comprising:
an electric motor equipped with a field winding with permanent magnets,
a speed reducer coupled to the said electric motor and to the said thermal engine,
a mounting support forming a housing, in which said electric motor and speed reducer are mounted,
the said speed reducer comprising a ring, at least one damping element intended to limit an angular movement due to a torsion movement between the speed reducer and the mounting support and at least one centring element intended to facilitate the assembly of the speed reducer and mounting support,
Which comprises at least one said damping element and at least one said centring element formed in a single elastic metal piece, and in that the elastic metal piece comprises an extension for holding the said permanent magnets.

2. Starting device for a thermal engine according to claim 1,
wherein the elastic metal piece is interposed between the ring of the speed reducer and the mounting support.

3. Starting device for a thermal engine according to claim 1,
wherein the elastic metal piece is fixed to the mounting support.

4. Starting device for a thermal engine according to claim 3,
wherein the elastic metal piece comprises an anchoring portion able to be fixed to the mounting support.

5. Starting device for a thermal engine according to claim 1,
wherein the elastic metal piece is circumferentially acting.

6. Starting device for a thermal engine according to claim 1,
wherein the ring comprises a recess receiving the elastic metal piece,

7. Starting device for a thermal engine according to claim 1,
wherein the elastic metal piece has a substantially longitudinal shape and has a substantially symmetrical transverse section comprising a planar central portion and two U or V-shaped parts on each side of the central portion.

8. Starting device for a thermal engine according to claim 1,
which comprises a plurality of elastic metal pieces disposed between the ring and the mounting support, the said elastic metal pieces being distributed substantially at a circumference of the said ring.

9. Starting device for a thermal engine according to claim 1,
wherein the elastic metal piece is produced by folding.
